(19) United States
(12) Patent Application Publication
(10) Pub. No.: US 2024/0311953 A1
(43) Pub. Date: Sep. 19, 2024

(54) GPU Processor System

(71) Applicant: METAX INTEGRATED CIRCUITS (SHANGHAI) CO., LTD., Shanghai (CN)

(72) Inventor: Jian YANG, SHANGHAI (CN)

(21) Appl. No.: 18/602,009

(22) Filed: Mar. 11, 2024

(30) Foreign Application Priority Data
Mar. 14, 2023 (CN) CN202310239277.9

(51) Int. Cl. G06T 1/60; G06F 13/42

(52) U.S. Cl. CPC G06T 1/60; G06F 13/4221; G06F 2213/0042

(57) ABSTRACT

The invention relates to the field of computer science, in particular to a GPU processor system. The system comprises a set of N GPU chips and a graphics memory H1ⱼ on a graphics card on which the GPU chip Cⱼ is mounted. Cⱼ includes a graphics memory controller MC1ⱼ and cross-chip interconnectors. The system further comprises graphics memory expansions. The graphics memory expansion Eᵢ comprises a graphics memory controller MC2ᵢ, a graphics memory H2ᵢ and a cross-chip interconnector SACᵢ. The q-th cross-chip interconnector FAC^{j}_{q} and SACᵢ are interconnected using a non-QPI interconnection bus. MC1ⱼ is unable to control access to H2ᵢ, and MC2ᵢ is unable to control access to H1ⱼ. Any processor other than Cⱼ has no access to MC2ᵢ, or the processor is given access to MC2ᵢ exclusively through FAC^{j}_{q} and SACᵢ if the processor has access to MC2ᵢ. Separate graphics memories special for GPU are increased in the system, without altering the hardware architectures of MC1ⱼ and GPU, while achieving higher compatibility and lower cost.

### RELATED APPLICATION

The application claims the benefit of CN202310239277.9 filed Mar. 14, 2023, which is incorporated herein by reference in its entirety.

### FIELD OF THE INVENTION

The present invention relates to the field of computer science, in particular to a GPU processor system.

### BACKGROUND OF THE INVENTION

In the field of computer science, typical processors include central processing units (CPU) and graphics processing units (GPU). Generally, a memory accessed by a CPU is called “an internal memory”, while that accessed by a GPU is called “a graphics memory”. The internal memory and the graphics memory may be memories with the same structures and/or parameters, or memories with different structures and/or parameters. A device for controlling the internal memory is usually called an internal memory controller, and a device for controlling the graphics memory is usually called a graphics memory controller.

There are two specific cases for a CPU to access an internal memory through an internal memory controller. In one case, the internal memory controller is set separately from the CPU, for example, the internal memory controller is incorporated in a north bridge chip, so that the CPU accesses the internal memory controller in the north bridge chip through a front side bus (FSB), thereby achieving an access to the internal memory. In the other case, the internal memory controller is integrated in the CPU, so that the CPU can access the internal memory controller and further the internal memory, without requiring a front side bus. Furthermore, the internal memory is usually installed in the internal memory slot of a motherboard in a pluggable way. For example, the internal memory slot may be a slot that supports dual inline memory modules (DIMM).

In case of inadequate memory capacity for a CPU, since the internal memory is pluggable, it is convenient to expand the internal memory by increasing the number of internal memories or replacing with an internal memory having a greater capacity. Furthermore, if there is a shortage in the number of internal memory slots, it is feasible to expand the internal memory by externally connecting with internal memory slots. For instance, the internal memory is expanded by externally connecting with an internal memory expansion chip using a QPI bus and/or SMI (Scalable Memory Interconnect) link. The patent CN103488436B gives an illustration on internal memory expansion based on external connection with an internal memory expansion chip using a QPI bus, and the patent CN205091735U involves internal memory expansion using the QPI bus and the SMI link. Obviously, these internal memory capacity expansion methods simply change the physical location of the expanding internal memory and the connection between the internal memory and the CPU, without changing the architecture among the CPU, the internal memory controller and the internal memory, that is to say, the CPU accesses the expanding internal memory via the internal memory controller.

Furthermore, symmetrical multi-processing can be used for sharing system memories, or non-uniform memory access is employed to share internal memories of different CPUs.

A GPU involves an integrated graphics card and a discrete graphics card.

The GPU on an integrated graphics card is integrated on a motherboard or inside other chips of the motherboard, usually has no separate graphics memory, and needs to share an internal memory with a CPU, that is, a configurable part of the internal memory is used for CPU and another configurable part of the internal memory is used for GPU. In this case, the access of GPU to the internal memory needs to go through the internal memory controller of the CPU, which means the access path includes the GPU, the internal memory controller of the CPU and the internal memory. When the capacity of the internal memory required by the GPU is inadequate, an internal memory can be added for the GPU by configuration.

The GPU integrated on a discrete graphics card is a separate chip irremovably coupled to the graphics card. The graphics card is connected to a motherboard via an interface bus. For example, the interface bus includes an accelerate graphical port (AGP) bus or a peripheral component interconnect express (PCIe) bus. For example, the fixation is welding. The GPU on a discrete graphics card usually has a graphics memory controller integrated therein and accesses a separate graphics memory through the graphics memory controller.

In the early days, in case of inadequate capacity of a graphics memory, the GPU on a discrete graphics card adopts processing similar to that of a CPU, i.e., increasing graphics memories via graphics memory slots or replacing with greater-capacity graphics memories. The graphics memory slots may be located on a motherboard or a graphics card on which the GPU is mounted. In addition, the graphics memories can be increased by externally connecting with a separate graphics memory expansion card via an interface. For example, Chinese patents CN203966018U and CN203720713U give introduction on the technology where the graphics memory slots are located on a motherboard; GeForce 6200A graphics cards from GALAXY involve the technology where the graphics memory slots are located on the graphics cards (https://tech.sina.com.cn/h/2005-04-8/1027596611.shtml?from=wap); and AV264+ graphics cards from ASUS involve the technology of standalone graphics memory expansion cards (https://www.163.com/mobile/article/BIGDIH0D0011309K.html). Obviously, these graphics memory capacity expansion methods simply change the physical location of a graphics memory and/or an expanding graphics memory and the connection between a graphics memory and a GPU, without changing the architecture among the GPU, a graphics memory controller and the graphics memory, that is, the GPU accesses the expanding graphics memory via the graphics memory controller.

The graphics memory expansion methods of GPU on a discrete graphics card in the early days have the following technical problems:
1. the slot or the interface for removable installation of a graphics memory occupies much physical space of a graphics card and/or a motherboard, which affects arrangement of other components on the graphics card and/or the motherboard, where the GPU is mounted, under the circumstance of significant improvement in the GPU function and/or performance; and
2. the number of pin interfaces of slots sees a great increase along with the significant improvement in memory function and/or performance, thereby posing a challenge to wiring between the GPU and the graphics memory.

In order to solve these problems, unlike CPUs and GPUs on discrete graphics cards in the early days, the graphics memories of high-performance GPUs of discrete graphics cards are packaged in the GPUs or irremovably coupled to the graphics cards on which the GPUs are mounted, so as to reduce physical space occupation and case the challenge posed by wiring. Since graphics memories are unalterable, graphics memory controllers of high-performance GPUs on discrete graphics cards are usually not specifically designed to be equipped with the function of supporting an additional expanding graphics memory. For example, the graphics memory of a high-performance GPU on a discrete graphics card is a high-bandwidth memory (HBM) or graphics double data rate (GDDR).

In the high-performance GPU on a discrete graphics card, the graphics memory accessible by a graphics memory controller is usually packaged in the GPU or irremovably coupled to a graphics card on which the GPU is mounted. To inadequate graphics memory capacity, there are two solutions. One solution is to learn from the access of an integrated graphics card to an internal memory and share the internal memory of a CPU, that is, the GPU accesses the internal memory of the CPU via the internal memory controller of the CPU through the interface between a graphics card and a motherboard. For example, the interface between a graphics card and a motherboard is, for instance, an AGP bus or PCIe bus. The other solution is to share graphics memories of other GPUs, that is, the GPU accesses the graphics memories of other GPUs interconnecting with the GPU through cross-chip interconnection interfaces. For example, the cross-chip interconnection interface involves NVLink and/or NVSwitch.

The graphics memory expansion methods of the high-performance GPU on a discrete graphics card have such a technical problem that it is unable to increase the upper limit of the internal memory and/or graphics memory of GPU and CPU or the upper limits of the graphics memories of the GPU and other GPUs, if no alteration is made to the graphics memory controller of GPU, since the GPU and the CPU share the internal memory, or the GPU and other GPUs share the graphics memory. When the CPU or other GPUs also need much internal memory or graphics memory, there poses a serious internal memory or graphics memory competition.

### OBJECTS AND SUMMARY OF THE INVENTION

In order to solve these technical problems, the invention aims to provide a processor system.

In one embodiment, the invention provides a GPU processor system. The system comprises a set of N GPU chips {C₁, C₂, . . . , Cⱼ, . . . , C_{N}} and a graphics memory H1ⱼ, which is irremovably coupled to a graphics card on which Cⱼ is mounted, wherein Cⱼ is the j-th GPU chip in the set of GPU chips, j is an integer ranging from 1 to N, and N is the number of GPU chips and a positive integer; Cⱼ includes an unalterable graphics memory controller MC1ⱼ and a set of N1(j) cross-chip interconnectors {FAC^{j}₁, FAC^{j}₂, . . . , FAC^{j}_{q}, . . . , FAC^{j}_{N1(j)}}, FAC^{j}_{q} is the q-th cross-chip interconnector on Cⱼ, q is an integer ranging from 1 to N1(j), and the function value of N1(j) is a positive integer; MC1ⱼ is configured to control access to H1ⱼ; the system further comprises M separate graphics memory expansions {E₁, E₂, . . . , Eᵢ, . . . , E_{M}}, Eᵢ is the i-th graphics memory expansion, i is an integer ranging from 1 to M, and M is the number of graphics memory expansions and a positive integer; Eᵢ includes a graphics memory controller MC2ᵢ, a graphics memory H2ᵢ and a cross-chip interconnector SACᵢ; and MC2ᵢ is configured to control access to H2ᵢ.

FAC^{j}_{q} and SACᵢ are interconnected using a non-QPI interconnection bus.

MC1ⱼ is unable to control access to H2ᵢ, and MC2ᵢ is unable to control access to H1ⱼ.

For any processor other than Cⱼ: the processor has no access to MC2ᵢ; or the processor is given access to MC2ᵢ exclusively through FAC^{j}_{q} and SACᵢ if the processor has access to MC2ᵢ.

The invention has the following advantages:
a processor system provided in the invention is connected with the cross-chip interconnector of a graphics memory expansion via the cross-chip interconnector of a GPU chip. The GPU chip accesses MC2ᵢ via the cross-chip interconnector of the GPU chip and the cross-chip interconnector of the graphics memory expansion, thereby accessing H2ᵢ, without requiring the alteration of MC1ⱼ inside a high-performance GPU or the replacement of H1ⱼ irremovably coupled to MC1ⱼ. It means separate graphics memories special for GPU can be increased, without altering the hardware structure of MC1ⱼ of the GPU or the overall hardware architecture of the GPU, while achieving higher compatibility and lower cost.

### BRIEF DESCRIPTION OF FIGURES

In order to clearly illustrate the technical solutions and advantages of embodiments of the invention or the prior art, a brief introduction is given hereinafter to the accompanying figures required in the description of the embodiments or the prior art. Obviously, the accompanying figures in the description hereinafter are only illustration of some embodiments of the invention. For those skilled in the art, other accompanying figures can be obtained on the basis of these figures without creative effort.

FIG. 1 is a system diagram of a GPU processor system provided in an embodiment of the invention.

### DETAILED DESCRIPTION OF THE EMBODIMENTS

In order to further elaborate the technical means and effects adopted in the invention to achieve predetermined purposes, a detailed description about the specific implementation, structures, features and effects of the GPU processor system based on the invention is given hereinafter in conjunction with accompanying figures and preferred embodiments. In the description hereinafter, different “one embodiment” or “another embodiment” may not necessarily refer to the same embodiment. In addition, specific features, structures, or characteristics in one or more embodiments may be combined in any proper form.

Unless otherwise defined, all the technical and scientific terms used herein have the same meanings as those commonly understood by those skilled in the art.

A GPU processor system provided in the invention is specifically illustrated in conjunction with the accompanying figure.

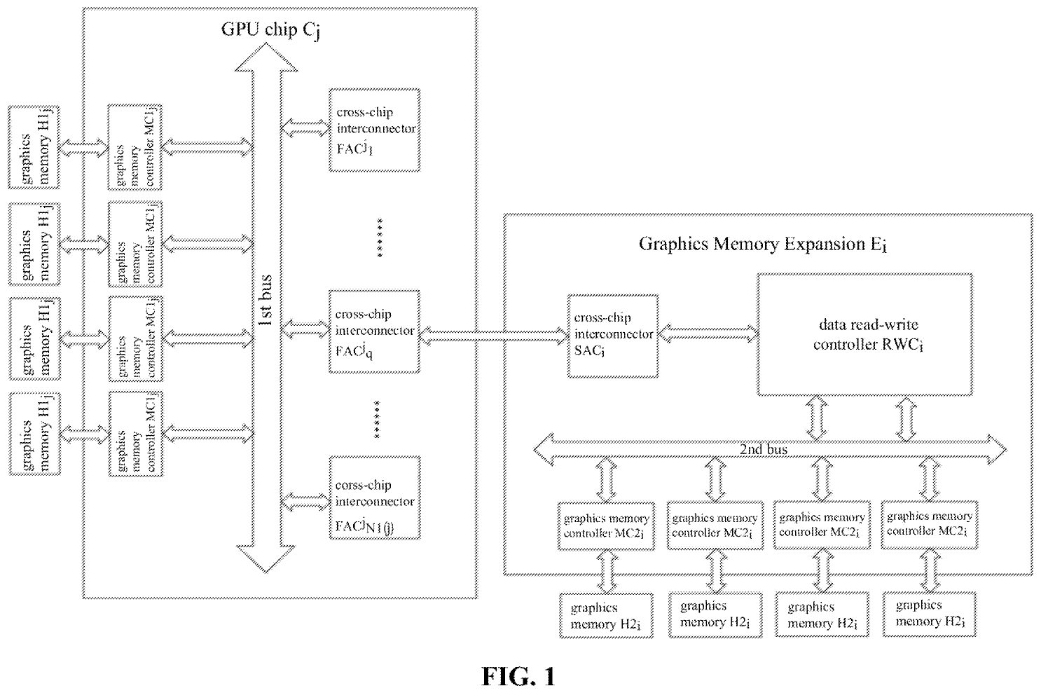

As shown in FIG. 1, a GPU processor system comprises a set of N GPU chips {C₁, C₂, . . . , Cⱼ, . . . , C_{N}} and a graphics memory H1ⱼ, which is irremovably coupled to a graphics card on which Cⱼ is mounted, wherein Cⱼ is the j-th GPU chip in the set of GPU chips, j is an integer ranging from 1 to N, and N is the number of GPU chips and a positive integer; Cⱼ includes an unalterable graphics memory controller MC1ⱼ and a set of N1(j) cross-chip interconnectors {FAC^{j}₁, FAC^{j}₂, . . . , FAC^{j}_{q}, . . . , FAC^{j}_{N1(j)}}, FAC^{j}_{q} is the q-th cross-chip interconnector on Cⱼ, q is an integer ranging from 1 to N1(j), and the function value of N1(j) is a positive integer; and MC1ⱼ is configured to control access to H1ⱼ.

Optionally, Cⱼ is a high-performance GPU chip internally provided with an interface for the cross-chip interconnector on Cⱼ to connect with a first bus.

Preferably, the GPU chip is one of graphics processors, general-purpose graphics processors and AI processors.

Preferably, H1ⱼ is a graphics memory complying with HBM or GDDR.

It should be noted that MC1ⱼ is integrated inside the GPU as an important component unit inside the GPU. MC1ⱼ is connected with H1ⱼ. If H1ⱼ is HBM, H1ⱼ is packaged together with a GPU chip; and if H1ⱼ is GDDR, H1ⱼ is welded on a graphics card on which the GPU chip is mounted.

Furthermore, the system further comprises a set of M separate graphics memory expansions {E₁, E₂, . . . , Eᵢ, . . . , E_{M}}. Eᵢ is the i-th graphics memory expansion, i is an integer ranging from 1 to M, and M is the number of graphics memory expansions and a positive integer; Eᵢ includes a graphics memory controller MC2ᵢ, a graphics memory H2ᵢ and a cross-chip interconnector SACᵢ; and MC2ᵢ is configured to control access to H2ᵢ, wherein Eᵢ does not include a GPU and/or CPU chip.

Preferably, H2ᵢ has a greater memory capacity than H1ⱼ and a lower bandwidth than H1ⱼ.

Preferably, the graphics memory H2ᵢ is a graphics memory complying with DDR or LPDDR.

Optionally, the graphics memory H2ᵢ is removably coupled to Eᵢ in such a manner that the graphics memory controller MC2ᵢ is interconnected with the graphics memory H2ᵢ via a DIMM interface, which is convenient for plugging, to facilitate replacement of the graphics memory H2ᵢ.

Optionally, Eᵢ includes a set of M(i) graphics memory controllers MC2ᵢ and a set of M(i) graphics memories H2ᵢ, wherein the M(i) graphics memories H2ᵢ may all comply with DDR; or they may all comply with LPDDR; or part of the graphics memories H2ᵢ comply with DDR while the remaining graphics memories H2ᵢ comply with LPDDR.

Furthermore, FAC^{j}_{q} and SACᵢ are interconnected using a non-QPI interconnection bus, wherein FAC^{j}_{q} and SACᵢ comply with the same interconnection bus protocol and have the same structure, FAC^{j}_{q} includes a physical layer, an adaptation layer and a protocol layer, and SACᵢ includes a physical layer, an adaptation layer and a protocol layer.

Optionally, the interconnection protocol bandwidth of FAC^{j}_{q} and SACᵢ is higher than that of a PCIe bus.

Preferably, FAC^{j}_{q} and SACᵢ are interconnected using a bus complying with one of MetaX Link, NVLink, Infinity Fabric and UCIe. It is understood that the maximum bandwidths of NVLink 1.0, NVLink 2.0 and MetaX Link can reach 160 GB/s, 300 GB/s and 128 GB/s, respectively; and the maximum bidirectional communication bandwidth of GPU connected by use of PCIe can reach 32 GB/s. Therefore, the bandwidth of a graphics memory expansion equipped with NVLink 1.0 is about five times that equipped with PCIe, the bandwidth of a graphics memory expansion equipped with NVLink 2.0 is about nine times that equipped with PCIe, and the bandwidth of a graphics memory expansion equipped with MetaX Link is about four times that equipped with PCIe.

Preferably, FAC^{j}_{q} and SACᵢ comply with UCIe, and an interconnector complying with UCIe has a power consumption lower than those complying with NVLink and Infinity Fabric.

FAC^{j}_{q} and SACᵢ adopt peer-to-peer connection which enables physical design and control logic simpler, and are configured for interconnection between a chip and a graphics memory expansion to realize shorter physical transmission distance, compared with memory sharing via PCIe, thereby greatly reducing time delay during data transmission. The peer-to-peer connection between FAC^{j}_{q} and SACᵢ needs to meet the condition that FAC^{j}ₚ and SACᵢ are not interconnected and FAC^{j}_{q} and SACₖ are not interconnected when FAC^{j}_{q} and SACᵢ are interconnected, wherein FAC^{j}ₚ is the p-th cross-chip interconnector on Cⱼ, SACₖ is a cross-chip interconnector on the k-th graphics memory expansion Eₖ, p≠q, and i≠k.

Preferably, when FAC^{j}_{q} is interconnecting with the p-th cross-chip interconnector (FAC^{k}ₚ) on the k-th GPU chip (Cₖ) in the set of GPU chips, FAC^{j}_{q} is unable to interconnect with SACᵢ, or when FAC^{j}_{q} is interconnecting with the cross-chip interconnector of a GPU chip, it is unable to interconnect with SACᵢ.

Optionally, when N=1 and M=1, the GPU processor system comprises one GPU chip and one graphics memory expansion connected with the GPU chip, in a one-to-one expansion structure.

Optionally, when N=1 and M>1, the GPU processor system comprises one GPU chip and a set of M graphics memory expansions connected with the GPU chip, in a one-to-many expansion structure.

Optionally, when N>1 and M>1, the GPU processor system may include a one-to-one expansion structure or a one-to-many expansion structure. Furthermore, the processor system may also include a one-to-one expansion structure and a one-to-many expansion structure at the same time.

Furthermore, MC1ⱼ is unable to control access to H2ᵢ, and MC2ᵢ is unable to control access to H1ⱼ.

It should be understood that Cⱼ accesses H1ⱼ through MC1ⱼ and accesses H2ᵢ through MC2ᵢ, both H1ⱼ and H2ᵢ are graphics memories dedicated to Cⱼ, and MC2ᵢ is directly accessed only by Cⱼ, thereby solving the problem of resource competition resulting from sharing of internal memory or graphics memory, and breaking through the upper capacity limit of an expanded dedicated graphics memory.

H1ⱼ and H2ᵢ adopt unified addressing. Specifically, Cⱼ comprises an address translation unit through which H1ⱼ and H2ᵢ are subjected to unified address conversion.

Optionally, Cⱼ further comprises a first interface bus for internal memory sharing with a CPU. Optionally, the first interface bus is an AGP bus or PCIe bus. It should be noted that internal memory sharing refers to the use of part of the internal memory as a graphics memory special for Cⱼ and the other part as an internal memory special for CPU. It means Cⱼ accesses the internal memory controller of CPU via the first interface bus, thereby accessing the storage space of the internal memory as the graphics memory special for Cⱼ via the internal memory controller of CPU.

Optionally, the bandwidth of H2ᵢ is higher than that of the internal memory shared by CPU.

Furthermore, for any processor other than Cⱼ: the processor has no access to MC2ᵢ; or the processor is given access to MC2ᵢ exclusively through FAC^{j}_{q} and SACᵢ if the processor has access to MC2ᵢ.

Preferably, Eᵢ further includes a data read-write controller RWCᵢ, RWCᵢ is connected with MC2ᵢ, and SACᵢ is connected with RWCᵢ; when RWCᵢ receives a first access command from Cⱼ through FAC^{j}_{q} and SACᵢ, RWCᵢ converts the first access command into a second access command, and transmits the second access command to MC2ᵢ; MC2ᵢ is unable to identify the first access command; and MC2ᵢ is configured to identify the second access command.

RWCᵢ is configured for converting command formats. When the first access command received by RWCᵢ fails to be identified by MC2ᵢ, RWCᵢ converts the first access command into the second access command and transmits the second access command via a second bus to MC2ᵢ which then issues read/write tasks to H2ᵢ. When the first access command is a data reading command, H2ᵢ will return data to Cⱼ sequentially through MC2ᵢ, the second bus, RWCᵢ, SACᵢ, and FAC^{j}_{q}. The return process is reverse to the access process so that the second access command needs to be converted back to the first access command, wherein the first and the second access command have different command formats. Specifically, the data packet of the first access command transmitted between Cⱼ and Eᵢ is bigger than that of the second access command transmitted inside Eᵢ. For example, the data packet of the first access command includes a 128 Byte read-write command, while the data packet of the second access command includes a 32 Byte read-write command. Before the first access command is converted into the second access command, SACᵢ parses the received first access command to obtain multiple read-write commands, and transmits the 32 Byte-256 Byte read-write commands in the unit of 4 KB virtual page to the data read-write controller RWCᵢ, so that RWCᵢ repacks the read-write commands to obtain the second access command.

Optionally, the protocol of the second bus is the AXI bus protocol.

Preferably, the graphics memory expansions are implemented on an FPGA or ASIC.

In summary, the processor system provided in the invention is connected with a graphics memory expansion via the cross-chip interconnector of GPU. The GPU accesses a graphics memory controller MC2ᵢ via the cross-chip interconnectors of Cⱼ and Eᵢ, thereby accessing a graphics memory of Eᵢ. Other processors have no access to MC2ᵢ, or other processors are given access to MC2ᵢ through the cross-chip interconnectors of Cⱼ and Eᵢ if other processors have access to MC2ᵢ. MC1ⱼ is unable to access H2ᵢ, and MC2ᵢ is unable to access H1ⱼ, so that H2ᵢ serves as a graphics memory special for GPU, without requiring the alteration of MC1ⱼ in a high-performance GPU, or the replacement of GDDR or HBM irremovably coupled to MC1ⱼ, that is to say, separate graphics memories special for GPU are increased, without altering the hardware structure of the graphics memory controller of GPU or the overall hardware architecture of GPU, while achieving higher compatibility and lower cost.

It should be noted that the order of the inventive embodiment mentioned hereinabove is only for description and does not imply strength and weakness of the embodiment. The specific embodiment of this specification is described hereinabove. Other embodiments fall into the scope of the attached claims. Under some circumstances, the actions or steps recorded in the claims can be performed in an order different from that in the embodiment but still can achieve desired results. In addition, the process described in the figure does not necessarily require the shown specific order or continuous order to achieve the desired results. In some embodiments, multitasking and parallel processing are also acceptable or may be advantageous.

Each embodiment in the specification is described in a progressive manner, the same and similar parts of each embodiment are mutually referable, and each embodiment focuses only on its difference from the other embodiments.

Hereinabove mentioned is only a preferred embodiment of the invention, and not intended to limit the invention. Any modification, equivalent replacement, improvement, etc. made within the spirit and principle of the present invention should be covered within the protection scope of the present invention.

What is claimed is:

1. A GPU processor system, comprising:
a set of N GPU chips {C₁, C₂, . . . , Cⱼ, . . . , C_{N}};
a graphics memory H1ⱼ, which is irremovably coupled to a graphics card on which Cⱼ is mounted; and
a set of M separate graphics memory expansions {E₁, E₂, . . . , Eᵢ, . . . , E_{M}}, wherein:
Cⱼ includes:
an unalterable graphics memory controller MC1ⱼ; and
a set of N1(j) cross-chip interconnectors {FAC^{j}₁, FAC^{j}₂, . . . , FAC^{j}_{q}, . . . , FAC^{j}_{N1(j)}};
MC1ⱼ is configured to control access to H1ⱼ;
Eᵢ includes:
a graphics memory controller MC2ᵢ;
a graphics memory H2ᵢ; and
a cross-chip interconnector SACᵢ;
MC2ᵢ is configured to control access to H2ⱼ;
FAC^{j}_{q} and SACᵢ are interconnected by a non-QPI interconnection bus;
MC1ⱼ is unable to control access to H2ᵢ;
MC2ᵢ is unable to control access to H1ⱼ;
for any processor other than Cⱼ:
the processor has no access to MC2ᵢ; or
the processor is given access to MC2ᵢ exclusively through FAC^{j}_{q} and SACᵢ if the processor has access to MC2ᵢ;
j is an integer ranging from 1 to N;
Cⱼ is the j-th GPU chip in the set of GPU chips;
q is an integer ranging from 1 to N1(j);
FAC^{j}_{q} is the q-th cross-chip interconnector on Cⱼ; and
i is an integer ranging from 1 to M.

2. The system in claim 1, wherein: FAC^{j}_{q} is unable to interconnect with SACᵢ when FAC^{j}_{q} is interconnecting with the p-th cross-chip interconnector (FAC^{k}ₚ) on the k-th GPU chip (Cₖ) in the set of GPU chips.

3. The system in claim 2, wherein FAC^{j}_{q} and SACᵢ are interconnected by a bus that complies with one of MetaX Link, NVLink, Infinity Fabric and UCIe.

4. The system in claim 1, wherein:
H2ᵢ has a greater memory capacity than H1ⱼ; and
H2ᵢ has a lower bandwidth than H1ⱼ.

5. The system in claim 4, wherein: H1ⱼ is a graphics memory complying with HBM or GDDR.

6. The system in claim 4, wherein: H2ᵢ is a graphics memory complying with DDR or LPDDR.

7. The system in claim 1, wherein:
Eᵢ further includes a data read-write controller RWCᵢ;
RWCᵢ is connected with MC2ᵢ;
SACᵢ is connected with RWCᵢ; and
when RWCᵢ receives a first access command from Cⱼ through FAC^{j}_{q} and SACᵢ:
RWCᵢ converts the first access command into a second access command;
RWCᵢ transmits the second access command to MC2ᵢ;
MC2ᵢ is unable to identify the first access command; and
MC2ᵢ is configured to identify the second access command.

8. The system in claim 1, wherein H2ᵢ is connected with MC2ᵢ via a DIMM interface.

9. The system in claim 1, wherein the GPU chip is one of graphics processors, general-purpose graphics processors and AI processors.

10. The system in claim 3, wherein:
FAC^{j}_{q} includes a physical layer, an adaptation layer and a protocol layer; and
SACᵢ includes a physical layer, an adaptation layer and a protocol layer.

11. The system in claim 1, wherein the graphics memory expansion is implemented on an FPGA or an ASIC.
